(19) United States
(12) Patent Application Publication
(10) Pub. No.: US 2006/0292278 A1
(43) Pub. Date: Dec. 28, 2006

(54) Feed supplement compositions

(76) Inventors: Roland Brugger, Freiburg (DE); Martin Gadient, Basel (CH); Patrick Guggenbuhl, Sainte-Crpoix-en-Plaine (FR); Werner Neupert, Erlangen (DE); Carlos Simoes-Nunes, Village-Neuf (FR); Bernd Vignudelli, Rheinfelden (DE)

Correspondence Address: NIXON & VANDERHYE, PC, 901 NORTH GLEBE ROAD, 11TH FLOOR, ARLINGTON, VA, 22203, US

(21) Appl. No.: 10/552,609

(22) PCT Filed: Apr. 6, 2004
(86) PCT No.: PCT/EP04/03647

§ 371 Date: Oct. 5, 2005

(30) Foreign Application Priority Data
Apr. 15, 2003 (EP) 03008638.3

(51) Int. Cl. A23L 1/00

(52) U.S. Cl. 426/516

(57) ABSTRACT

A process for the preparation of thermostable, discrete, solid particles containing lactoferrin embedded in a protein- and/or starch-based carrier matrix by mixing the carrier matrix, lactoferrin and an optional internal lubricant in a horizontal screw extruder, extruding and cutting said mixture into pieces and optionally drying said pieces as well as their use as food or animal feed supplements.

The present invention relates to a process for the preparation of compositions with improved properties for use in nutrition, especially in animal nutrition and to the compositions thus obtained.

More precisely, the present invention relates to a process for the preparation of compositions useful as food or feed supplements comprising lactoferrin and to the compositions thus obtained.

The present invention also relates to the use of compositions comprising lactoferrin as a food feed supplement, especially for improving the health status of animals and to feed compositions comprising a supplement on the basis of lactoferrin.

Lactoferrin is a naturally occurring single chain glycoprotein with a molecular weight of about 80′000 D containing 1-4 glycan units which can be isolated from milk or milk derivatives of many animals by different methods.

U.S. Pat. No. 4,791,193 describes a method for the preparation of bovine lactoferrin in high purity wherein bovine milk is contacted with a weakly acidic cation exchange resin containing carboxymethyl groups and eluting the adsorbed lactoferrin with sodium chloride solutions.

WO 89/04608 discloses a process for extracting pure lactoperoxidase and lactoferrin from milk serum. The milk serum is microfiltered and passed through a strong cation exchanger at a high flow rate for selective adsorption of lactoferrin and lactoperoxidase and selective and successive elution with saline solutions of different concentrations.

British patent application No. 2179947 discloses the isolation of lactoferrin from whey by ultrafiltration and weak cation exchange chromatography at approximately neutral pH.

WO 93/13676 discloses a process for isolating lactoferrin from milk or whey by adsorbing it to a cation exchange resin at a high superficial velocity and at a high liquid load, eluting it with a salt solution, e.g., sodium chloride in phosphate buffer, and, optionally, drying it.

WO 95/22258 reports a method for substantially purifying human lactoferrin from milk including the milk of a transgenic animal harboring a gene which encodes the expression and secretion of human lactoferrin in its milk by contacting the milk with a strong cation exchange resin under elevated ionic strength conditions and eluting the human lactoferrin with a stepwise or linear salt gradient.

WO 02/096215 describes an industrial process for the isolation of bovine lactoferrin and other proteins from large volumes of, e.g., milk or milk derived products such as whey, using Expanded Bed Adsorption (EBA) technology. The liquid is applied to high density adsorption material with a mean particle size of at most 150 μm and a particle density of at least 1.5 g/ml followed by elution of the protein from the adsorbent.

Lactoferrin has iron-binding properties, exhibits antimicrobial and antiviral activity and shows immunomodulatory functions in the host-defense system.

Lactoferrin has therefore been used as feed additive to increase the growth and health status of animals.

U.S. Pat. No. 4,726,948 discloses anti-bacterial compositions comprising lactoferrin and lactoperoxidase for the treatment of gastrointestinal infections as components of foodstuff and animal feedstuff.

U.S. Pat. No. 4,977,137 discloses lactoferrin from non-processed milk as a dietary ingredient which promotes growth of the gastrointestinal tract of human infants and infant non-human animals.

U.S. Pat. No. 5,656,591 discloses the use of antimicrobially active peptides derived from lactoferrins in combination with an antibiotic for the treatment of foods and non-medical products.

It is an object of the present invention to provide lactoferrin containing granules with improved product properties suitable for nutrition, especially for animal nutrition, and a process for the manufacture thereof. The invention also relates to animal feed enriched with the improved lactoferrin containing granules.

While different lactoferrin species may exist which differ in the number and sequence of amino acids as well in the glycan moiety, the term “lactoferrin” as used herein below comprises all these different molecules irrespective of their origin, whether natural or synthetic, prepared by purification from a natural source, by classical chemical synthesis or by recombinant methods, as long as the molecule has a homology of at least 60% in amino acid sequence with a naturally occurring lactoferrin molecule and exhibits at least one of its biological activities, especially its antimicrobial activity. The term “sequence homology” or “homology in sequence” relates to amino acid sequences which can be longer or shorter than that of a naturally occurring molecule with one or multiple exchanges, insertions and/or deletions of one or more amino acids. Homology of at least 60% includes homologies of 70, 75, 80, 85, 90, 95, or higher percentages. The term “lactoferrin” includes lactoferrin on the market; lactoferrin isolated from mammalian (humans, cows, sheep, goats, horses, camels, etc.) milk, such as colostrum, transitional milk, matured milk, milk in later lactation, or from processed products thereof, such as skim milk, evaporated skim milk, butter milk, milk protein concentrate, whey, cheese whey, casein whey, desalted whey or whey concentrate. The lactoferrin of preferred interest is bovine lactoferrin. It is produced in large amounts from whey which is a by-product from the cheese manufacturing process. Different processes are known and used in the production of bovine lactoferrin comprising different chromatographic procedures and including a final drying step of the purified and concentrated lactoferrin-containing solution. Non-formulated lactoferrin thus obtained, viz. after drying by a conventional drying process, such as freeze drying, spray drying, or vacuum drying, in more or less dry form and free-flowing, however, in the form of a fine powder, is then blended with the feedstuff or with a carrier material to yield first a premix which is useful as feed additive. During that multi-step procedure which is complex, denaturation and loss of biological activity occurs on each stage and the compositions obtained, containing the lactoferrin in highly dispersed form, are further subject to degradation and do not possess a high shelf-stability.

The present invention overcomes this disadvantage and provides specifically formulated lactoferrin compositions which are shelf-stable, in the form of discrete, solid particles which contain lactoferrin embedded in a particular carrier matrix.

WO 98/18610 discloses a multistep method for continuously encapsulating or embedding a component in a matrix comprising admixing a compound with a cooled plasticized matrix material in the presence of a plasticizer under low shearing conditions, extruding said formable mixture through a die to obtain an extrudate and cutting said extrudate into pieces. The specification mentions more than eight hundred compounds specifically which can be embedded in such a plasticized matrix material in the presence of a plasticizer and shows in FIG. 1 a schematic representation of the process using a commercially available extruder. FIGS. 2 and 3 show schematically extrusion processes, exemplary extruder barrel and screw configurations.

The present invention uses a similar technology as described in WO 98/18610 for the preparation of thermostable, discrete, solid particles containing lactoferrin embedded in a protein- and/or starch-based carrier matrix. The process of the present invention is characterized by the steps of
(a) adding to a horizontal screw extruder the carrier matrix, lactoferrin and, optionally, an internal lubricant,
(b) mixing these components in the extruder under low shear and temperature conditions to obtain a homogeneous formable mixture,
(c) extruding and cutting said formable mixture-into pieces and, optionally,
(d) drying said pieces.

The invention also relates to the use of the above defined particles, especially when prepared according to the above-defined process, as food or animal feed supplements, to such supplement compositions themselves and finally to food or animal feed supplemented with such a supplement composition.

In accordance with the process of the present invention the discrete, solid particles or granules can be prepared in any horizontal screw extruder via pasta extrusion using an appropriate extrusion screw configuration for achieving low shear and low temperature mixing. For example, a combination of alternating small pitch conveying elements with distributive mixing elements, that are staggered at an angle to each other for providing axially oriented leakage flow inside the extruder barrel may be employed. The combination of alternating conveying elements with distributive mixing and kneading elements cause the material flow to be continuously interrupted without shearing of the mass thus resulting in mixing of the material at low mechanical energy input. Co-rotating intermeshing twin screw extruders, such as those available from Buhler, Switzerland; Clextral, France; Werner and Pfleiderer, Germany, APV, England or Wenger, USA; or a Co-Kneader, available from Buss, Switzerland, are preferred, since they provide superior mixing action compared to other single screw extruders.

The carrier matrix consists of edible components, well-tolerated by animals. The main components are protein containing ingredients and all types of starches, naturally occurring, in purified and/or chemically modified form or as constituents of ground cereals, such as cereal flours or grits, preferably a cereal or cereal byproduct. In a preferred embodiment mere starch-based mixtures, especially mixtures of wheat starch and durum wheat flour (semolina) are used.

Lactoferrin is added to the carrier matrix either in form of a solution (diluted or concentrated) or as a powder (more or less dry), if desired in form of a premix.

To the carrier matrix there may be added, if desired, agents influencing the hydrophobicity or the water-binding capacity of the matrix. The addition of hydrophobic compounds helps to prevent or delay penetration of water or gastric juice into the matrix thereby delaying the release of the embedded lactoferrin. Compounds with high water binding capacity may bind water which penetrates the particles or prevent water from dissolving the matrix thereby also preventing or delaying the release of lactoferrin from the carrier matrix. The additional compounds used to control the rate of release of lactoferrin may be used in amounts of up to 30% (w/v), preferably from about 5-15% (w/w).

To the carrier matrix may also be added vegetable oils or fats as an internal lubricant for the mixing and extrusion process and to avoid the formation of dust. This is particularly desirable when lactoferrin is added to the matrix in form of a dry powder. Any commercially available vegetable oil may be used and added up to about 10% (w/w), preferably up to about 5% (w/w) of the final weight of the solid particles. A particularly preferred oil is refined soy oil.

Finally, physiologically active and compatible minerals, such as magnesium, zinc or sodium salts, e.g., sulfates, and salts having an impact on the pH value, e.g., acetates, citrates or phosphates may be added to the carrier matrix in amounts to be adapted to the actual needs.

The proportion (w/w) of the carrier matrix in the feed supplement composition is at least 50%, e.g., from about 60-95% and preferably about 75%.

The components of the carrier matrix can be blended and introduced into the screw extruder as a premix or can be added individually. Lactoferrin can also be added already to the premix as a dry powder and be introduced into the extruder together with the carrier matrix. However, it is preferred to add lactoferrin as a solution separately to moisten the mixture. Alternatively, an oil component is added separately as internal lubricant. During homogenizing and extrusion the extruder is cooled to secure a temperature in the extruder and of the mixture, viz. under working conditions, of below 60° C., normally of from 20-50° C., preferably 35-40° C.

The lactoferrin to be used in the present process is commercially available lactoferrin or can be prepared in accordance with methods described in the state of the art. The preferred source is bovine milk or whey. The purity of the lactoferrin is not essential but should be at least 80%, preferably greater than 90% and in case of freeze dried material is normally 90-95%.

In the process of the present invention lactoferrin is added to the extruder preferably in form of a solution since this is the form in which it is obtained in most of the processes of its production from milk or whey, viz., by elution from an absorption column. The preferred technology for obtaining purified lactoferrin from milk or whey is the EBA technology, as described, e.g., in WO 02/096215, WO 01/85329 or WO 99/65586, contents of which is herewith explicitly incorporated into the present specification.

The lactoferrin content of the granules into which lactoferrin is embedded is from about 6% to about 50% (w/w) and in specific embodiments preferably 8-12% (w/w) or about 20-30% (w/w).

The homogenized mixture is extruded through a die plate and the extruded pasta strands are cut into distinct spherical particles.

The shape and dimensions of these granules of the present invention are dependent mainly on the form and diameters of the extrusion dies, the speed by which the mixture is extruded and the speed of the cutter and to a lesser extent on the conditions of a subsequent drying process. Convenient extrusion dies may have aperture diameters of 0.1-5 mm, preferably 0.5-1 mm. About 85% of the resulting particles have a size of 0.2-0.8 mm, preferably 0.3-0.6 mm.

The extrudate rope may be cut at the die face using a rotating cutter, pelletizer or rotating knives. In other embodiments, the extrudate rope may be cut away from the die using conventional cutting or forming means for producing pellets or tablets. The cut pieces may have a length: diameter ratio (l/d ratio) of about 0.5 to 10, preferably about 1. Depending upon their moisture the granules are more or less dust-free and edgy.

In accordance with the process of the present invention, the particle size may be varied to control the surface to volume ratio of the pellets or granules for achieving a desired controlled release of the lactoferrin. The particle size may be varied, for example, by the use of different diameters for the extrusion die openings. Particle size may also be varied by the use of a variable speed cutter either at the die plate at the end of the extruder or away from the extruder after the ropes have been conveyed for a short distance. By varying the speed of the cutter, the size of the cut pieces may be varied for a given extruder throughput. The use of a variable cutter which is spaced a short distance from the die plate, for example, between about 0.5 meters to about 5 meters permits further surface cooling, further surface drying, and reduces stickiness to provide better cutting of the ropes into pellets.

After cutting, the resulting pieces or granules may be dried to a sufficiently low moisture content which assures a sufficiently prolonged storage stability of shelf life. For example, the pellets may be dried to achieve a storage stability or shelf life of at least about nine months, preferably at least about eighteen months.

The drying may be performed using conventional drying equipment using drying temperatures which do not adversely affect the stability of lactoferrin. Exemplary drying temperatures may range from about 10° C. to about 90° C., preferably from about 200° C. to about 60° C. The drying may be conducted to achieve a moisture content of less than about 30% by weight, preferably less than about 12% weight, for example, from about 6% to about 9% by weight. A preferred drying method uses a fluid-bed dryer. After drying the particles may be less edgy due to mutual abrasion. If desired, the dried particles may be coated with film-building substances to provide them with specific desirable attributes using conventional coating apparatus and methods.

The granules into which lactoferrin is embedded in accordance with the present invention are useful as food or feed additives and can be mixed or processed with conventional and specific feed for all kinds of animals including humans, e.g., pigs, ruminants, poultry, fish, pets or animals to be found in zoological gardens, in amounts to provide a desired daily uptake, normally of about 0.5 to about 200 mg lactoferrin/kg body weight of animal depending upon its type, age and/or health state. If desired the feed supplemented with the lactoferrin granules is pelleted using a conventional type of pellet press. It is obvious to those skilled in the art that the particles of the present invention although mainly useful as supplements for animal feed can also be used for the production of other formulations, e.g., cosmetic or pharmaceutical preparations.

Because of their favorable particle size and the fact that the lactoferrin is embedded in a stabilizing matrix the granules of the present invention have improved properties, especially as feed additives when compared with non-embedded lactoferrin.

Lactoferrin embedded into a granulated carrier matrix in accordance with the present invention does not only exhibit an improved stability and longer shelf-live and is more slowly released in the gastrointestinal tract when compared with non-embedded freeze-dried material but surprisingly increases gastrointestinal absorption of amino acids, the feed conversion rate (FCR) and the daily weight gain of the animal. These effects have been found, e.g., in anastomosed pigs and weaner piglets, respectively.

The solid lactoferrin-containing particles in a thermostable form of the present invention do not only provide resistance against negative influences of elevated temperatures and prolonged time of storage but also against higher temperatures, e.g. above 80° C., to which feed is exposed during processing.

The invention is further illustrated by the following examples.

### EXAMPLE I

To a double-screw extruder type WP 58 Continua 22.5 kg of wheat starch, 12.5 kg of durum wheat flour and 12.5 kg Lactoferrin were added as a premix. Water to moisten the mixture and 2.5 kg of soy oil (refined) were added separately. During homogenizing and extrusion the extruder was cooled and kept at a temperature not exceeding 35° C. using saturated brine.

The homogenized mixture was extruded through a pelletizing die plate (diameter of dies: 0.5 mm) and the extruded pasta strands were cut at the die plate into pieces of about 0.5 mm length using a rotating cutter. After extrusion the lactoferrin containing granules were dried using a fluid bed dryer at an intake air temperature of max. 50° C.

The following composition was used to prepare granules useful as animal feed additive:

| | % (w/w) |
|---|---|
| Lactoferrin | 25 |
| Wheat starch | 45 |
| Durum wheat flour (semolina) | 25 |
| Soy oil (refined) | 5 |

In further embodiments compositions with different weight ratios of the above components were used under the same process conditions:

| | % (w/w) | | |
|---|---|---|---|
| Lactoferrin | 12 | 25 | 50 |
| Wheat starch | 40 | 40 | 3 |
| Durum wheat flour | 43 | 15 | 42 |
| Wheat gluten | — | 12 | — |
| Soy oil | 5 | 8 | — |
| Peanut oil, hardened | — | — | 5 |

### EXAMPLE II

To a double-screw extruder type WP 58 Continua 20.0 kg of wheat starch, 24.5 kg of durum wheat flour were added as a premix. An enriched lactoferrin solution obtained via chromatography of whey concentrated to about 25% protein content (of which about 90% was LF) was added. 2.5 kg of soy oil (refined) were added separately. During homogenizing and extrusion the extruder was cooled and kept at a temperature not exceeding 35° C. using saturated brine.

The following composition was used to prepare granules useful as animal feed additive:

| | % (w/w) |
|---|---|
| Lactoferrin (dry matter) | 6 |
| Wheat starch | 40 |
| Durum wheat flour (semolina) | 49 |
| Soy oil (refined) | 5 |

In further embodiments compositions with different weight ratios, adding an enriched lactoferrin solution with about 30% protein content (of which about 90% was LF) were used under the same process conditions:

| | % (w/w) | | |
|---|---|---|---|
| Lactoferrin (dry matter) | 6 | 8 | 10 |
| Wheat starch | 41.5 | 39.5 | 37.5 |
| Durum wheat flour (semolina) | 47.5 | 47.5 | 47.5 |
| Soy oil (refined) | 5 | 5 | 5 |

1. A process for the preparation of thermostable, discrete, solid particles containing lactoferrin embedded in a protein-and/or starch-based carrier matrix which process is characterized by the steps of
(a) adding to a horizontal screw extruder the carrier matrix, lactoferrin and, optionally, an internal lubricant,
(b) mixing these components in the extruder under low shear and temperature conditions to obtain a homogeneous formable mixture,
(c) extruding and cutting said formable mixture into pieces and, optionally,
(d) drying said pieces.

2. A process as claimed in claim 1 wherein the carrier matrix comprises wheat starch and durum wheat flour.

3. A process as claimed in claim 1 wherein lactoferrin is added in form of an aqueous solution or a dry powder.

4. A process as claimed in claim 1 wherein a vegetable oil is used as internal lubricant.

5. A process as claimed in claim 1 wherein the temperature in the extruder under working conditions is below about 60° C.

6. Thermostable, discrete, solid particles containing lactoferrin embedded in a protein- and/or starch-based carrier matrix.

7. Thermostable, discrete, solid particles containing lactoferrin embedded in a protein- and/or starch-based carrier matrix obtained by a process as claimed in claim 1.

8. Solid particles according to claim 6 for use as animal feed or food supplements.

9. A food or animal feed supplement composition on the basis of solid particles according to claim 6.

10. A food or an animal feed supplemented with a composition as claimed in claim 9.
